(19) United States
(12) Patent Application Publication
(10) Pub. No.: US 2026/0122618 A1
(43) Pub. Date: Apr. 30, 2026

(54) CARRYING ADDITIONAL FCS AND BSS COLOR INFORMATION IN UHR FRAMES

(71) Applicant: Samsung Electronics Co., Ltd., Suwon-si (KR)

(72) Inventors: Vishnu Vardhan Ratnam, Frisco, TX (US); Bilal Sadiq, Plano, TX (US); Boon Loong Ng, Plano, TX (US); Peshal Nayak, Plano, TX (US); Rubayet Shafin, Frisco, TX (US); Yue Qi, Plano, TX (US)

(21) Appl. No.: 19/353,586

(22) Filed: Oct. 8, 2025

Related U.S. Application Data
(60) Provisional application No. 63/714,534, filed on Oct. 31, 2024.
(60) Provisional application No. 63/733,776, filed on Dec. 13, 2024.
(60) Provisional application No. 63/779,877, filed on Mar. 28, 2025.
(60) Provisional application No. 63/801,457, filed on May 7, 2025.
(60) Provisional application No. 63/804,299, filed on May 12, 2025.
(60) Provisional application No. 63/824,587, filed on Jun. 16, 2025.

(51) Int. Cl. H04W 72/0446; H04W 74/00

(52) U.S. Cl. CPC H04W 72/0446; H04W 74/002

(57) ABSTRACT

An electronic device includes a transceiver configured to receive, from another electronic device, at least a first portion of a frame, the first portion including a preliminary frame check sequence (FCS) value. The electronic device also includes a processor operably coupled to the transceiver. The processor is configured to, based on the preliminary FCS value, perform a first cyclic redundancy check (CRC) on bits included in the first portion of the frame occurring before the preliminary FCS value, and based on a result of the first CRC, determine whether to continue reception of the frame.

### CROSS-REFERENCE TO RELATED APPLICATION(S) AND CLAIM OF PRIORITY

This application claims priority under 35 U.S.C. § 119(e) to U.S. Provisional Patent Application No. 63/714,534 filed on Oct. 31, 2024, U.S. Provisional Patent Application No. 63/733,776 filed on Dec. 13, 2024, U.S. Provisional Patent Application No. 63/779,877 filed on Mar. 28, 2025, U.S. Provisional Patent Application No. 63/801,457 filed on May 7, 2025, U.S. Provisional Patent Application No. 63/804,299 filed on May 12, 2025, and U.S. Provisional Patent Application No. 63/824,587 filed on Jun. 16, 2025. The above-identified provisional patent applications are hereby incorporated by reference in their entirety.

### TECHNICAL FIELD

1 This disclosure relates generally to wireless networks. More specifically, this disclosure relates to carrying additional frame check sequence (FCS) and basic service set (BSS) color information in ultra-high reliability (UHR) frames.

### BACKGROUND

Wireless Local Area Network (WLAN) technology allows devices to access the internet in the 2.4 GHz, 5GHz, 6GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for carrying additional FCS and BSS color information in UHR Frames.

In one embodiment, an electronic device is provided. The electronic device includes a transceiver configured to receive, from another electronic device, at least a first portion of a frame, the first portion including a preliminary frame check sequence (FCS) value. The electronic device also includes a processor operably coupled to the transceiver. The processor is configured to, based on the preliminary FCS value, perform a first cyclic redundancy check (CRC) on bits included in the first portion of the frame occurring before the preliminary FCS value, and based on a result of the first CRC, determine whether to continue reception of the frame.

In another embodiment, an electronic device includes a processor. The processor is configured to generate a frame that includes an FCS value in a first portion of the frame. The electronic device also includes a transceiver operably coupled to the processor. The transceiver is configured to transmit the frame to another electronic device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents and standards descriptions are hereby incorporated into the present disclosure as if fully set forth herein: [1] IEEE 802.11-2020, “Wireless LAN Medium Access Control (MAC) and Physical Layer (PHY) Specification”; [2] IEEE P802.11ax/D8.0; [3] IEEE P802.11be/D3.0; [4] 11-22/2204r0, “UHR Dynamic Subband Operation”; [5] 11-23-1496r0, “UHR EMLSR Dynamic Subband Operation”; [6] 11-23-843r1, “Considerations on Dynamic Subchannel Operation”; [7] 11-23-1873r0, “Post FCS MAC padding”; [8] 11-23-0034-01-0uhr-non-primary-channel-utilization; [9] 11-23/1965r0—Dynamic Power Save follow up; [10] 11-24/1227r1—Some usage of intermediate fcs; [11] WD-202401-016-1-US0-Using trigger frame for dynamic sub-band operation; and [12] 11-23-0034-01-0uhr-non-primary-channel-utilization.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example wireless network where infrastructure traffic and non-infrastructure traffic coexist according to embodiments of the present disclosure;

FIG. 4 illustrates an example element according to embodiments of the present disclosure;

FIG. 5 illustrates an example method performed by a transmitter for inclusion of BSS color and/or Preliminary FCS information with a transmitted frame according to embodiments of the present disclosure;

FIG. 6 illustrates an example of the inclusion of BSS Color and/or Preliminary FCS within a trigger frame according to embodiments of the present disclosure;

FIG. 7 illustrates an example of the inclusion of BSS Color and/or Preliminary FCS within a Preliminary FCS element according to embodiments of the present disclosure;

FIG. 8 illustrates an example of the inclusion of BSS Color and Preliminary FCS fields within a table of A-control fields according to embodiments of the present disclosure;

FIG. 9 illustrates an element according to embodiments of the present disclosure;

FIG. 10 illustrates element according to embodiments of the present disclosure;

FIG. 11 illustrates an example method performed by a receiver that supports reception of BSS color and/or Preliminary FCS information within a received frame according to embodiments of the present disclosure;

FIG. 12 illustrates an example method performed by an AP for enabling indication of BSS Color and/or Preliminary FCS and performing an FCS check on a received preliminary FCS according to embodiments of the present disclosure;

FIG. 13 illustrates an example method performed by a non-AP STA for supporting indication of BSS Color and/or Preliminary FCS and performing an FCS check on a received preliminary FCS according to embodiments of the present disclosure;

FIG. 14 illustrates an example method for carrying additional FCS and BSS color information in UHR frames according to embodiments of the present disclosure; and

FIG. 15 illustrates another example method for carrying additional FCS and BSS color information in UHR frames according to embodiments of the present disclosure.

### DETAILED DESCRIPTION

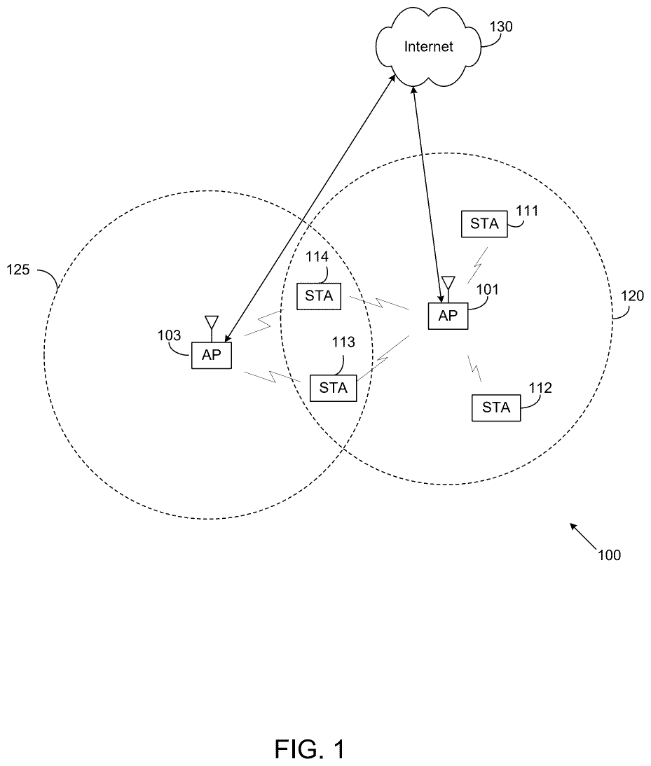

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device. ” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

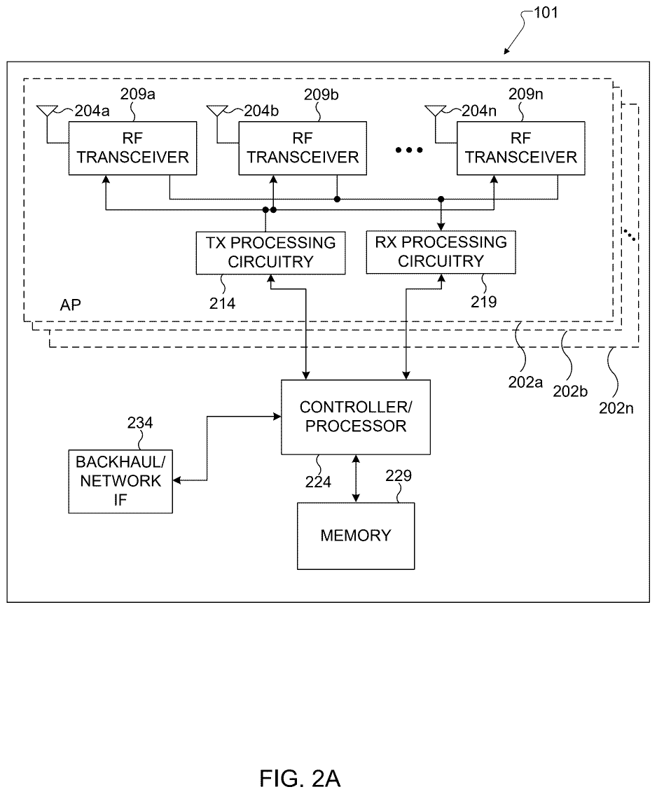

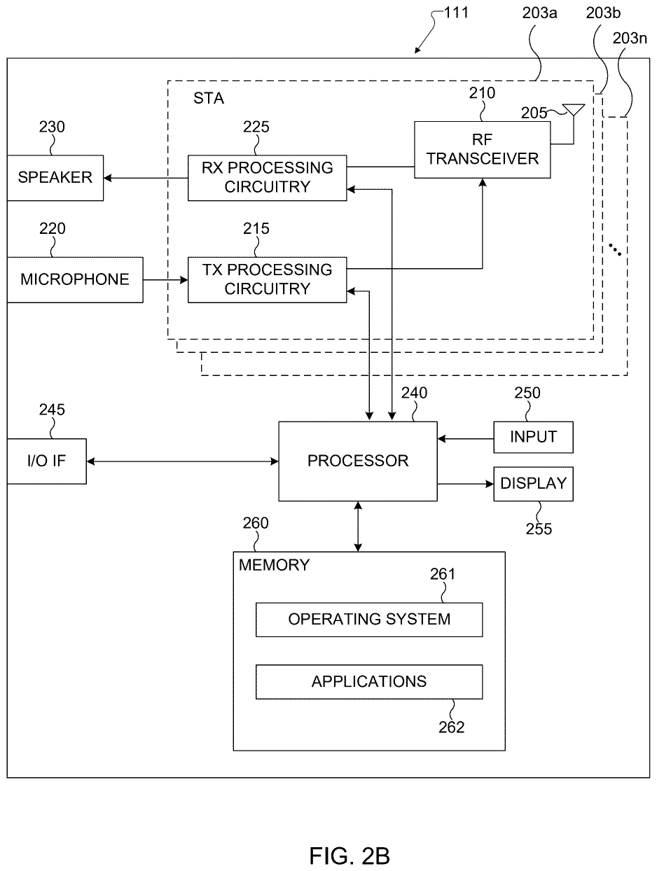

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

It is expected that several frames in future wireless networks may be transmitted in existing frame formats. Such frames may include:
Broadcast frames like beacons, group-addressed data frames etc.
Initial control frames (ICFs), such as request to send (RTS)/clear to send (CTS), trigger frames etc.

It has been proposed that future wireless networks may use ICFs for:
Multi-AP coordination for obtaining cross-basic service set (BSS) channel state information (CSI), buffer status, resource allocation etc.
Coexistence Indication
Initiating switch to higher capability state in Dynamic Power Save (DPS) operation
Initiating Dynamic Sub-band Operation (DSO) sub-band switch
Initiating transmission on backup primary channel in Non-primary Channel Access (NPCA).

It is expected that trigger frames in future wireless networks may have several features:
The trigger frames are expected to be the first transmission of a transmission opportunity (TXOP).
The trigger frames are expected to be transmitted in non-HT duplicate physical layer protocol data unit (PPDU) format.
The trigger frames are expected to contain padding (up to 256us) to provide the receiver time for performing some operations.

In order to support some devices modes such as DSO, DPS, etc., where the device needs some time to reconfigure its capabilities, an intermediate frame check sequence (FCS) field has been proposed for inclusion in trigger frames. This intermediate FCS may be present in a trigger frame after signaling to the DSO and DPS STAs, but before the padding field. This enables the DSO, DPS STAs to validate the frame check before the padding field, so that the STAs can perform the reconfiguration during the padding field.

A mechanism called spatial reuse has been proposed. In this mechanism, a STA transmitting an HE PPDU includes in the transmitted frame a field called a BSS Color field which includes a number to help identify the BSS to which the transmitted frame belongs. According to spatial reuse, if a STA receives a PPDU that is determined to belong to a neighboring overlapping BSS and it is determined that the PPDU allows spatial reuse, then the STA is allowed to transmit in parallel to the observed PPDU. However, the STA may have to reduce its transmit power to not cause interference to the observed PPDU on the air. This transmit power is a function of the power of the received PPDU. The goal of the spatial reuse mechanism is to enhance spectrum utilization in the network.

According to existing wireless networking procedures, an AP or an associated non-AP STA can transmit on any non-primary channel only if the AP or associated non-AP STA also transmits on the primary channel. If the primary channel is busy due to an overlapping basic service set (OBSS) TXOP, then no transmission is permitted, even if there is a secondary channel that is idle. This can increase the channel access delay and reduce the efficiency of channel utilization. As a solution to this issue, the mechanism of NPCA has been proposed. When an AP enables NPCA operation, the AP may also disclose one or more back-up 20 MHz primary channels. If an OBSS transmission occupies the primary channel of the AP for a certain duration, the AP and associated non-AP STAs that support NPCA may switch to one of the back-up primary channels for performing frame exchanges, while treating that backup channel as the temporary primary channel till the end of the duration on the main primary channel. These exchanges may continue until either:
The end of the PPDU duration set by the OBSS transmission on the primary channel.
The end of the NAV duration set by the OBSS transmission on primary channel.

The two variants above may be referred to as PPDU duration based NPCA and network allocation vector (NAV) duration based NPCA, respectively. The duration for which transmissions on the backup channel can continue may be referred to as the NPCA Duration. In some embodiments, the AP and non-AP STAs may return to the primary channel by the end of this NPCA Duration. This return time may be referred to as the NPCA Switchback Time.

Pre-high efficiency (HE) PPDUs have several limitations: (i) they contain NAV information within the MAC header and (ii) they lack BSS color information. If a frame is in pre-HE PPDU format, a receiving STA has to decode the whole frame and perform an FCS check to validate the NAV information. This causes unnecessary wastage of power at the STA, especially if the STA is not an intended recipient of the PPDU. For larger PPDUs, the FCS check may have a higher probability of failure, especially at a neighboring OBSS. This also degrades performance of features like NPCA or spatial reuse, which rely on successful reception of a frame from an OBSS, its BSS Color and/or NAV information. As the use cases for the trigger frame as the initial control frame are increasing and the length of trigger frames are increasing (due to padding for example), these problems are further exacerbated.

The present disclosure provides mechanisms for a transmitting STA to include an additional FCS field and a BSS Color indication early within a transmitted frame. The present disclosure also provides mechanisms for a receiving STA to use the aforementioned indications to early terminate the reception of the PPDU, while also obtaining a valid NAV and/or BSS Color information that can be used for other features.

As described herein, the term frame check sequence (FCS) check may refer to performing a check of correctness of a received FCS value. This may also be referred to as a cyclic redundancy check (CRC) or CRC check.

In some embodiments, ultra-high reliability (UHR) media access control (MAC) frames or UHR-variants of existing MAC frames may carry, after the MAC header (early within the Frame body), one or more of:
a BSS color value, and
a preliminary FCS value.

In some embodiments, the value of this preliminary FCS may be computed based on the bits that occur before the preliminary FCS field. In embodiments, such as these, non-AP UHR (or beyond) STAs that are not expected to receive the MAC frame (e.g., if the transmit address is from an unknown AP or RA is not addressed to the STA) may use this preliminary FCS value to early terminate the decoding process of the frame. The Packet Error Rate may also be reduced since the frame segment before the preliminary FCS may be smaller.

In some embodiments, the preliminary FCS may be different from MAC header protection. This is so that the preliminary FCS may be decodable by any unassociated STA.

In some embodiments, the preliminary FCS can be identical to an intermediate FCS design, and use same field format, etc. When applicable, the same FCS field can be used for both of:
supporting the switching operation in DSO, DPS, enhanced multi-link single radio (EMLSR) etc., and
enabling early termination of reception of the PPDU while also providing valid NAV and BSS color information.

In other words, a preliminary FCS can be identical to an intermediate FCS in some embodiments.

For convenience, the present disclosure uses the terms FCS check and cyclic redundancy check (CRC) interchangeably to mean the checking if the value of the CRC in the FCS field at a receiver matches the expected value or not.

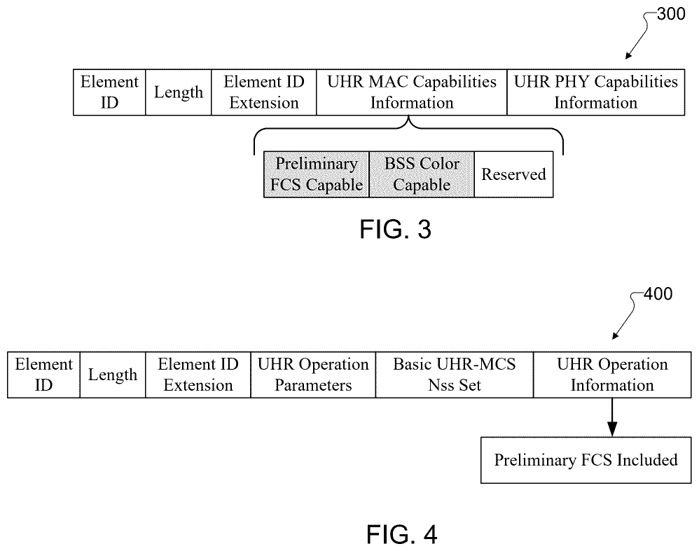

In some embodiments, an AP and/or a non-AP STA may indicate in a UHR capabilities element, whether the AP or non-AP STA is capable of including a preliminary FCS value, and/or a BSS Color value within the body of a MAC frame it transmits, similar as shown in FIG. 3.

FIG. 3 illustrates an example UHR capabilities element within a MAC frame 300 according to embodiments of the present disclosure. The embodiment of a UHR capabilities element of FIG. 3 is for illustration only. Different embodiments of a UHR capabilities element could be used without departing from the scope of this disclosure.

In the example of FIG. 3, the MAC frame 300 includes the following fields:
Element ID
Length
Element ID extension
UHR MAC Capabilities Information
UHR PHY Capabilities information.

The UHR MAC Capabilities Information may include the following indication fields:
Preliminary FCS Capable
BSS Color Capable
Reserved.

In some embodiments, the indication fields may be 1 bit. For example, the bit may be set to 1 to indicate the associated feature is supported, and may be set to 0 otherwise. In some embodiments, the indication fields may include a common field for both Preliminary FCS and BSS Color indication support. In embodiments such as these, the common field can be the Preliminary FCS Capable field. In some embodiments, the capability of including Preliminary FCS and/or BSS Color may be mandatory beyond a certain Wi-Fi generation, such as UHR and beyond.

Although FIG. 3 illustrates one example UHR capabilities element within a MAC frame 300, various changes may be made to FIG. 3. For example, various changes to indications within the UHR capabilities element could be made, etc. according to particular needs.

In some embodiments, an AP may indicate via broadcast signaling (e.g., in beacons, probe response, association response etc.) whether preliminary FCS and/or BSS Color will be included by the AP in MAC frames that the AP transmits that satisfy any necessary criteria. In some embodiments, the AP may also indicate whether an associated UHR STA that is capable of including the Preliminary FCS and/or BSS Color, is expected to include a Preliminary FCS in any frames that the UHR STA transmits that satisfies necessary criteria. In some embodiments, these indications may be carried in a Preliminary FCS Included field of a UHR Operation element, similar as shown in FIG. 4.

FIG. 4 illustrates an example element 400 according to embodiments of the present disclosure. The embodiment of an element of FIG. 4 is for illustration only. Different embodiments of an element could be used without departing from the scope of this disclosure.

In the example of FIG. 4, the element 400 is a UHR Operation element transmitted by an AP. The element 400 includes the following fields:
Element ID
Length
Element ID extension
UHR Operation Parameters
Basic UHR-MCS and Nss Set
UHR Operation Information.

The UHR Operation Information may include a field indicating whether preliminary FCS is and/or BSS color information is included in frames transmitted by the AP. In some embodiments, this field may be 1 bit. For example, the field may be set to 1 to indicate that Preliminary FCS is included by the AP and is requested to be included by associated STAs. The field may be set to 0 otherwise.

Although FIG. 4 illustrates one example element 400, various changes may be made to FIG. 4. For example, various changes to indications within the element could be made, etc. according to particular needs.

In some embodiments, a non-AP STA may indicate whether the non-AP STA will include preliminary FCS and/or BSS Color information in one or more types of frames the non-AP STA transmits by carrying a signaling in a frame the non-AP STA transmits to the AP. This frame can be, for example, an action frame.

In some embodiments, the inclusion of Preliminary FCS and/or BSS Color can be defined for all MAC frames. In some embodiments, the inclusion of Preliminary FCS and/or BSS Color can be defined for or specific types of MAC frames. For example, the inclusion of Preliminary FCS and/or BSS Color can be defined for one or more of: control frames, trigger frames, group addressed frames etc. In some embodiments, a BSS Color and/or Preliminary FCS may be included in a MAC frame if the frame satisfies certain criteria. For example, the criteria may be based on one or more of:
Whether the transmitting STA is capable of including those fields (as described above with respect to FIG. 3)
The PPDU format in which the MAC frame is being transmitted
The type of MAC frame being transmitted
Whether the frame is an individually addressed frame or a broadcast frame
The duration of the MAC frame
The NAV duration set by the MAC frame.
Whether the MAC frame is updating the NAV that has previously been set.
Whether an intermediate FCS value is already present in the frame, etc.
Whether the AP has indicated to include the values (as described above with respect to FIG. 4)
   A few examples of such criteria include:
Example 1: the preliminary FCS may only be included if the MAC frame is sent in a certain legacy PPDU format such as non-HT PPDU or non-HT duplicate PPDU format.
Example 2: the preliminary FCS may only be included in a MAC frame if the MAC frame duration is larger than a predetermined threshold that is set by the standard.
Example 3: If the NAV for a transmit TXOP has already been indicated by the transmission of a different frame (e.g. RTS/CTS etc.) before transmission of the MAC frame, and the MAC frame is not updating the TXOP duration, the Preliminary FCS may not need to be carried within the MAC frame.
Example 4: If a PPDU already includes an Intermediate FCS value indication, the preliminary FCS value may not be included.

In some embodiments, the criteria may include one or more of the following examples:
Example 1: the preliminary FCS may be included if the MAC frame is sent in a certain legacy PPDU format such as non-HT PPDU or non-HT duplicate PPDU format.
Example 2: the preliminary FCS may be included in a MAC frame if the MAC frame duration is larger than a predetermined threshold that is defined in a standardization document, such as a document of the IEEE 802.11 series of standards.
Example 3: If the NAV for a transmit TXOP has already been indicated by the transmission of a different frame (e.g. RTS/CTS etc.) before transmission of the MAC frame, and the MAC frame is not updating the TXOP duration, the Preliminary FCS may not need to be carried within the MAC frame.
Example 4: If a PPDU already includes an Intermediate FCS value indication, the preliminary FCS value may not be included.

In some embodiments the presence of BSS Color and/or Preliminary FCS within a MAC frame may be implementation specific.

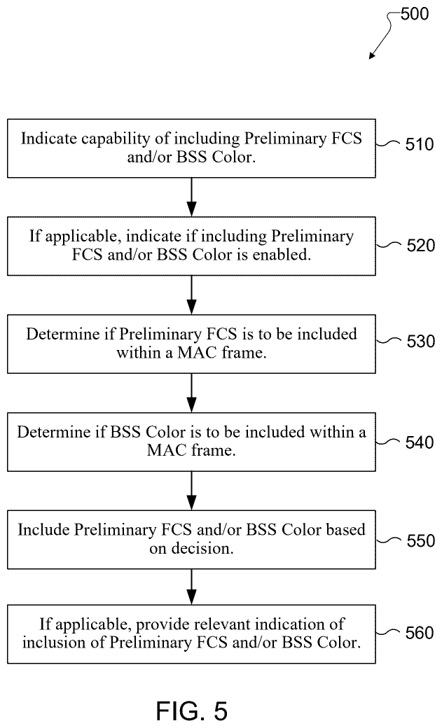

An illustration of behavior of a transmitting device (which may be referred to hereinafter as a “transmitter”) such as an AP or non-AP STA regarding inclusion of BSS Color and/or Preliminary FCS information within a transmitted frame is shown in FIG. 5.

FIG. 5 illustrates an example method performed by a transmitter for inclusion of BSS color and/or Preliminary FCS information with a transmitted frame 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a method for inclusion of BSS color and/or Preliminary FCS information with a transmitted frame could be used without departing from the scope of this disclosure.

In the example of FIG. 5, the method 500 begins at step 510. At step 510, a transmitting device (such as an AP) indicates to a receiving device (such as a non-AP STA) a capability of including Preliminary FCS and/or BSS color in a MAC frame. At step 520, if applicable, the transmitter indicates if including Preliminary FCS and/or BSS Color is enabled.

At step 530, the transmitter determines whether Preliminary FCS is to be included within a MAC frame, and at step 540, the transmitter determines whether BSS Color is to be included within the MAC frame.

At step 550, based on the determination made at steps 530 and 540, the transmitter includes or excludes Preliminary FCS and/or BSS color in the MAC frame. At step 560, if applicable, the transmitter provides a relevant indication of inclusion of Preliminary FCS and/or BSS Color within the MAC frame.

Although FIG. 5 illustrates one example method performed by a transmitter for inclusion of BSS color and/or Preliminary FCS information with a transmitted frame 500, various changes may be made to FIG. 5. For example, while shown as a series of steps, various steps in FIG. 5 could overlap, occur in parallel, occur in a different order, occur any number of times, be omitted, or replaced by other steps.

To indicate BSS Color and/or Preliminary FCS the MAC frame may include one or more of:
A BSS Color Field
A Preliminary FCS field
A presence indication of the BSS color field and/or preliminary FCS field MAC frame; and
A location indication of the BSS color field and/or preliminary FCS field within the MAC frame.

In some embodiments, the presence of a BSS Color value may be optional within a MAC frame, and the MAC frame may include a BSS Color Present bit indicating whether a BSS Color value is present in the MAC frame. In some embodiments, the presence of a Preliminary FCS value may be optional within a MAC frame, and the MAC frame may include a Preliminary FCS Present bit indicating whether a Preliminary FCS value is present in the MAC frame. In some embodiments, a MAC frame may include a location field to indicate the start location of either the BSS Color or the Preliminary FCS field within the MAC frame. The BSS Color field, if present, may indicate the BSS color of the BSS of which the transmission belongs.

The Preliminary FCS field, if present, may have a fixed length and the value of the Preliminary FCS may be computed based on the bits that occur before the preliminary FCS field. In some embodiments, the field may have a length of 32 bits, and a computation mechanism for the preliminary FCS may be similar to the computation mechanism of a conventional FCS. In some embodiments, the field may have a length smaller than 32 bits (e.g., N bits, where N<32). In some embodiments, the pre-FCS polynomial can be chosen to be of degree 32 but the most significant N bits of the remainder (upon performing FCS computation on all bits up to the Preliminary FCS) can be carried in the N bits. In some embodiments, the Preliminary FCS polynomial can be chosen to be of a length smaller than N bits to generate an FCS value of length N.

In some embodiments, if both BSS Color and Preliminary FCS information are present in the MAC frame, then the BSS Color information may precede the Preliminary FCS value in the MAC frame. The BSS Color and Preliminary FCS fields may be implemented within the MAC frame such that STAs that are incompatible with the information within the BSS Color and Preliminary FCS fields which are intended recipients of the frame may ignore the fields. In some embodiments, the BSS Color and/or Preliminary FCS may be split across multiple subfields to achieve this functionality.

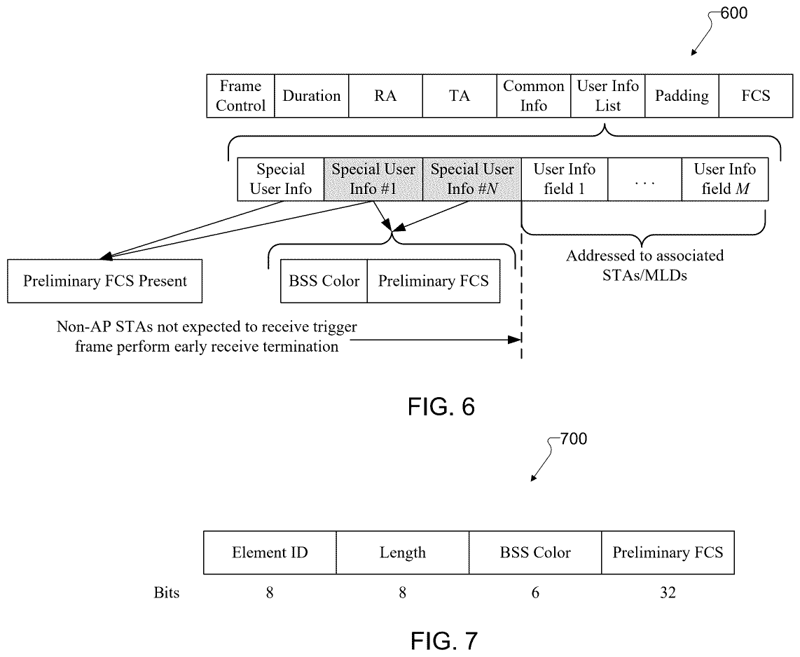

In trigger frames, in some embodiments, the BSS Color and/or preliminary FCS values can be carried across one or more User Info fields with pre-defined association identifier (AID) values, and the BSS Color and/or preliminary FCS values can be present before any of the User Info fields that address non-AP STAs associated with the AP. In some embodiments, the User Info field that carries the BSS Color and/or Preliminary FCS can be, for example, the same as the Special User Info field that carries the extension of the Common Info field, or the User Info field that carries the BSS Color and/or Preliminary FCS can be an extension of the Special User Info field or a new Special User Info field with a specific 12-bit AID (AID12) value. In some embodiments, there may be a BSS Color Present bit and/or Preliminary FCS Present bit in the Common Info field (or Special User Info field that extends the Common Info), indicating whether the BSS Color or Preliminary FCS value is present in the frame. In some embodiments, there may be a Preliminary FCS Location field in the Common Info field (or in a Special User Info field that extends the Common Info, [i.e., that carries additional information common to multiple STAs]), indicating the location of the Preliminary FCS in the frame. The value may indicate the count of User Info fields present before the field carrying the Preliminary FCS value, starting from the Common Info field or starting from the Special User Info field carrying the preliminary FCS location indication. An example of such inclusion within a trigger frame is depicted in FIG. 6. In a variant of this example, the Preliminary FCS may be present between the User Info List and Padding field.

FIG. 6 illustrates an example of the inclusion of BSS Color and/or Preliminary FCS within a trigger frame 600 according to embodiments of the present disclosure. The embodiment of a trigger frame of FIG. 6 is for illustration only. Different embodiments of inclusion of BSS Color and/or Preliminary FCS within a trigger frame could be used without departing from the scope of this disclosure.

In the example of FIG. 6, the trigger frame 600 includes the following fields:
Frame Control
Duration
RA
TA
Common Info
User Info List
Padding
FCS.

The User Info List field may include the following subfields
Special User Info: this field indicates whether BSS Color or Preliminary FCS value is present in the trigger frame 600
Special User info #1-#N: One or more of these fields may indicate the location of the preliminary FCS or carry the FCS value. For example, a value in Special User info field #1 may include a value indicating a count of user info fields present before the field carrying the Preliminary FCS value.
User infoo fields 1-M.

Although FIG. 6 illustrates one example inclusion of BSS Color and/or Preliminary FCS within a trigger frame 600, various changes may be made to FIG. 6. For example, various changes to indications within the User Info List element could be made, etc. according to particular needs.

In some embodiments, the BSS Color and/or Preliminary FCS may be carried in a new element, similar as shown in FIG. 7. This element may be referred to as a Preliminary FCS element.

FIG. 7 illustrates an example of the inclusion of BSS Color and/or Preliminary FCS within a Preliminary FCS element 700 according to embodiments of the present disclosure. The embodiment of a Preliminary FCS element of FIG. 7 is for illustration only. Different embodiments of inclusion of BSS Color and/or Preliminary FCS within a Preliminary FCS element could be used without departing from the scope of this disclosure.

In the example of FIG. 7, the Preliminary FCS element 700 includes the following fields:
Element ID
Length
BSS Color
Preliminary FCS.

In some embodiments, Preliminary FCS element 700 can be included by an AP in some individually addressed and group-addressed frames, such as beacon frames, etc. In embodiments such as these, capable non-AP STAs which do not intend to receive the beacon frame can early terminate the decoding process of the frame after parsing this element. The legacy STAs which can't parse the element may just ignore the element.

Although FIG. 7 illustrates one example inclusion of BSS Color and/or Preliminary FCS within a Preliminary FCS element 700, various changes may be made to FIG. 7. For example, various changes to indications within the Preliminary FCS element could be made, etc. according to particular needs.

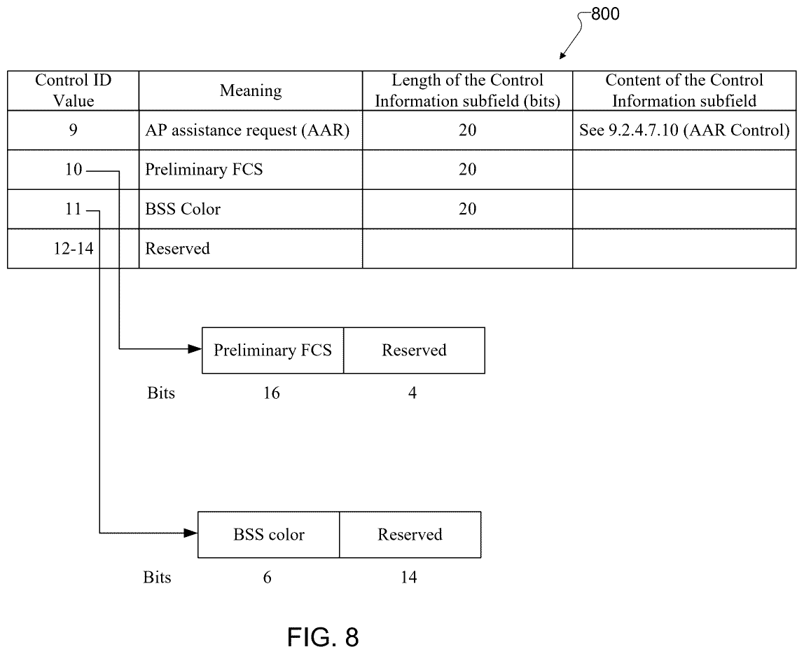

In some embodiments, the Preliminary FCS value can be carried in a new aggregated-control (A-control) variant similar as depicted in FIG. 8. This new A-control variant may be referred to as Preliminary FCS A-control.

FIG. 8 illustrates an example of the inclusion of BSS Color and Preliminary FCS fields within a table of A-control fields 800 according to embodiments of the present disclosure. The embodiment of A-control fields of FIG. 8 is for illustration only. Different embodiments of inclusion of BSS Color Preliminary FCS within a table of A-control fields could be used without departing from the scope of this disclosure.

In the example of FIG. 8, in some embodiments, the Preliminary FCS may be of a shorter length than an existing FCS (e.g., of 16 bits). In some embodiments, the least significant 4 bits of the BSS Color may also be included in the A-control field within the remaining 4 bits. In some embodiments, the BSS Color may occupy 6 bits, and the Preliminary FCS may occupy 14 bits.

Although FIG. 8 illustrates one example inclusion of BSS Color and Preliminary FCS within a table of A-control fields 800, various changes may be made to FIG. 8. For example, various changes to the control ID values could be made, etc. according to particular needs.

In some embodiments, the Preliminary FCS and/or BSS Color information can be carried in the QoS Control field of the MAC header.

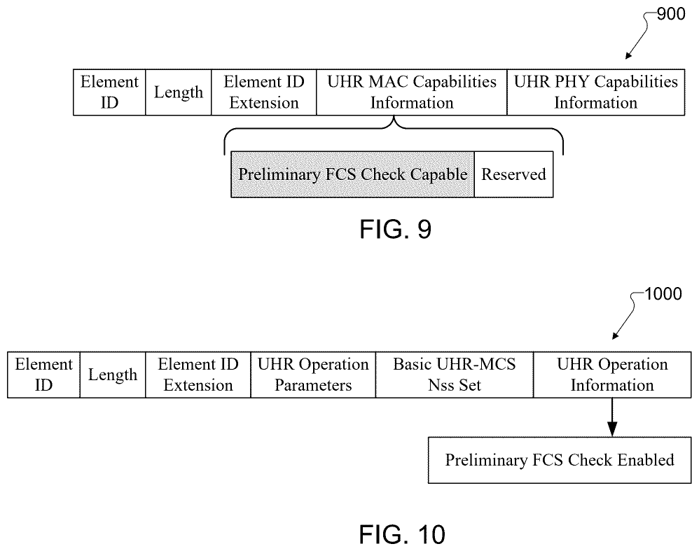

In some embodiments, it may be mandatory for Wi-Fi STAs beyond a certain generation (e.g., UHR), to be capable of performing check of the preliminary FCS, if present in a received frame. In some embodiments, it may be optional for a Wi-Fi STA to be capable of performing check of the preliminary FCS, if present in a received frame. In some embodiments, there may be a capability signaling field transmitted by the STA, that can be set to 1 to indicate that the STA is capable of performing a check of the preliminary FCS in a received frame, and can be set to 0 otherwise. This field can be carried, for example, in the UHR PHY Capabilities Information or UHR MAC Capabilities Information fields of the UHR Capabilities element. This field may be called, for example, “Preliminary FCS Check Capable”, similar as shown in FIG. 9. In some embodiments, there may be a single field that jointly indicates whether the STA is capable of including the Preliminary FCS in a transmitted frame and capable of performing the FCS check on the Preliminary FCS value from a received frame.

FIG. 9 illustrates an example element 900 according to embodiments of the present disclosure. The embodiment of an element of FIG. 9 is for illustration only. Different embodiments of an element could be used without departing from the scope of this disclosure.

In the example of FIG. 9, the element 900 is a UHR Capabilities element, and it includes the following fields:
Element ID
Length
Element ID extension
UHR MAC Capabilities Information
UHR PHY Capabilities information.

The UHR MAC Capabilities Information may include the following indication fields:
Preliminary FCS Check Capable
Reserved.

Although FIG. 9 illustrates one element 900, various changes may be made to FIG. 9. For example, various changes to indications within the element could be made, etc. according to particular needs.

In some embodiments, it may be mandatory for Wi-Fi STAs beyond a certain generation (e.g., UHR) to perform check of the preliminary FCS, if present in a received frame. In some embodiments, it may be optional for a Wi-Fi STA to perform check of the preliminary FCS, if present in a received frame.

In some embodiments, an AP may indicate whether it will perform the FCS check on the preliminary FCS that is present in any received frames. This signaling can be, for example, in broadcast frames such as in beacons, probe response, association response etc. In some embodiments, this indication may be carried in a “Preliminary FCS Check Enabled” field of the UHR Operation element, similar as shown in in FIG. 10.

FIG. 10 illustrates an example element 1000 according to embodiments of the present disclosure. The embodiment of an element of FIG. 10 is for illustration only. Different embodiments of an element could be used without departing from the scope of this disclosure.

In the example of FIG. 10, the element 1000 is a UHR Operation element transmitted by an AP. The element 1000 includes the following fields:
Element ID
Length
Element ID extension
UHR Operation Parameters
Basic UHR-MCS and Nss Set
UHR Operation Information.

The UHR Operation Information may include a field indicating whether the AP indicate whether it will perform an FCS check on the preliminary FCS that is present in any received frames. In some embodiments, the field may be set to 1 to indicate that the FCS check is performed on the Preliminary FCS values in a received frame. The field may be set to 0 otherwise.

Although FIG. 10 illustrates one example element 1000, various changes may be made to FIG. 10. For example, various changes to indications within the element could be made, etc. according to particular needs.

In some embodiments, the AP may also indicate if an associated UHR STA, that is capable of performing an FCS check on Preliminary FCS may do so for any received frames that include a Preliminary FCS value that satisfies certain criteria. This indication may be applicable to all associated STAs or associated STAs that satisfy some criteria, e.g., STAs participating in NPCA operation etc. In embodiments such as these, the AP may also indicate the criteria for performing the FCS check on the preliminary FCS, that may be used by the AP and/or applicable associated STAs. For example, in some embodiments, the criteria may include one or more of:
The operation of the AP in one or more modes (e.g., NPCA, DPS, DSO, EMLSR etc.).
A determination of whether the PPDU is an intra-BS PPDU.
The PHY version of the PPDU being received.
The type of MAC frame being received.
Whether the frame is an individually addressed frame or a broadcast frame.
The duration of the MAC frame.
The NAV duration set by the MAC frame.
Whether the MAC frame is updating the NAV that has previously been set.
Whether a preliminary FCS or intermediate FCS value is present in the frame.
The location of the preliminary FCS within the frame, etc.

In some embodiments, a non-AP STA may also indicate whether or not the non-AP STA will perform an FCS check on the Preliminary FCS fields present in a received frame, by transmitting a signaling to the AP. This signaling can be contained, for example, in the Probe Request, Association Request or an Action frame sent by the non-AP STA to the AP.

In some embodiments, the aforementioned indications can be of whether an AP or non-AP STA performs early termination of reception of a PPDU based on an FCS check of the preliminary FCS.

In some embodiments, when the receiver MAC of a STA (that is capable of receiving the Preliminary FCS) that detects a pre-HE PPDU receives a PHY-RXSTART. indication primitive, the STA may check for preliminary FCS in the frame. If the Preliminary FCS is present, the STA may optionally choose to early terminate the reception of the PPDU after performing a check of the Preliminary FCS value, if one or more of the following conditions are satisfied:
The MAC header of the frame suggests that the STA is not an expected recipient.
If the check of the Preliminary FCS value fails.
The STA has indicated that it will perform FCS check on a Preliminary FCS if present in a received frame.
The CRC check on the preliminary FCS field passes, and the STA is not expected to receive any of the fields of the transmitted frame present after the preliminary FCS field.

In some embodiments, a STA beyond a certain Wi-Fi generation (e.g., a UHR STA) that determines an initial control frame reception as successful or unsuccessful based on the CRC check on the preliminary FCS, if present, may terminate reception of the frame without performing a CRC check on the FCS field. In some embodiments, a STA that does not determine an initial control frame reception as successful or unsuccessful based on the CRC check on the preliminary FCS, if present in the frame, may not terminate reception of the frame without performing a CRC check on the FCS field.

In some embodiments, the receiver's MAC sublayer may send a primitive to the PHY sublayer to terminate the frame decoding process of the packet. In one example, the primitive can be a variant of an existing primitive such as PHY-RXEND. indication, that can be sent from the MAC sublayer to PHY sublayer. In another example, the primitive can be a new primitive sent from the MAC sublayer to PHY sublayer, called PHY. RXENDREQUEST. indication(). In embodiments such as these, if the FCS check on the Preliminary FCS fails, the STA may defer channel contention until the end of PPDU duration indicated in the PHY header. If the FCS check on Preliminary FCS passes, the STA may set the NAV duration based on the NAV indicated in the MAC header of the frame. In one example, the NAV set may be the basic BSS NAV. In another example the NAV set may be the intra-BSS NAV if the PPDU containing the received frame can be classified as an intra-BSS PPDU and can be the basic NAV otherwise. Other existing rules on setting the NAV, related to classification of the PPDU as intra-BSS or inter-BSS, the received signal power being above some thresholds, e.g., −82 dBm may still apply. In one embodiment, if an FCS check on Preliminary FCS passes, the information including the NAV information and/or BSS Color information can be used for several Wi-Fi features. For example, for triggering Non-primary channel access (NPCA) operation, Spatial reuse operation, for performing multi-AP coordination features, etc. In other words, the successful CRC check on the preliminary FCS field of a received frame may be treated by the receiver as a successful reception of the frame. Correspondingly, the NAV update procedures or other procedures (some of which are discussed above) may be followed. In some cases, the successful CRC check on the preliminary FCS field may not be sufficient to qualify a received frame as being successfully received. For example, if the frame is addressed to the receiver and/or the receiver is expected to receive some fields of the frame that are present after the preliminary FCS field, it may then not treat the frame as being received successfully just based on the successful CRC check on the preliminary FCS. In this case, the receiver may decide about successful reception based on the success of CRC check of the FCS field at the end of the frame.

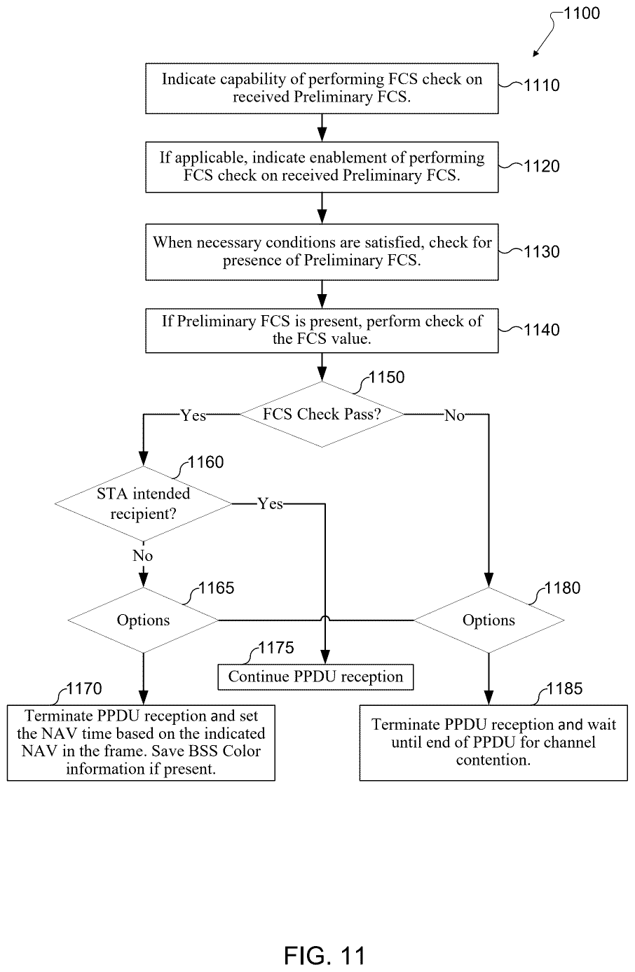

An illustration of behavior of a receiving device (which may be referred to hereinafter as a “receiver”) such as an AP or non-AP STA if the STA supports reception of BSS Color and/or Preliminary FCS information is shown in FIG. 11.

FIG. 11 illustrates an example method performed by a receiver that supports reception of BSS color and/or Preliminary FCS information within a received frame 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for performed by a receiver that supports reception of BSS color and/or Preliminary FCS information within a received frame could be used without departing from the scope of this disclosure.

In the example of FIG. 11, the method 1100 begins at step 1110. At step 1110, a receiving device (such as a non-AP STA) indicates to a transmitting device (such as an AP) a capability of performing an FCS check based on a received preliminary FCS. At step 1120, if applicable, the receiver indicates if performing an FCS check based on a received Preliminary FCS is enabled.

At step 1130, when necessary conditions are satisfied, the receiver determines whether a Preliminary FCS is included within a MAC frame, and at step 1140, if a preliminary FCS is present, the receiver performs a check of the FCS value.

At step 1150, the receiver determines whether the check of the FCS value performed at step 1140 passes. If the FCS check passes, the method proceeds to step 1160. Otherwise, if the FCS check does not pass, the method proceeds to step 1180.

At step 1160, the receiver determines whether the receiver is the intended recipient of the MAC frame. If the receiver is not the intendent recipient, then the method proceeds to step 1165. Otherwise, if the receiver is the intended recipient, the method proceeds to step 1175.

At step 1165, the receiver evaluates whether one or more conditions are satisfied. Depending on a result (for example, a particular combination of conditions being satisfied), the method may proceed to step 1170 or 1180.

At step 1170, the receiver terminates PPDU reception and sets a NAV time based on the indicated NAV in the frame. The receiver also saves the BSS color information if present within the MAC frame.

At step 1175, the receiver continues PPDU reception.

At step 1180, the receiver evaluates whether one or more conditions are satisfied. Depending on a result (for example, a particular combination of conditions being satisfied), the method may proceed to step 1165 or 1185.

At step 1185, the receiver terminates PPDC reception and waits until the end of the PPDU to perform channel contention.

Although FIG. 11 illustrates one example method performed by a receiver that supports reception of BSS color and/or Preliminary FCS information within a received frame 1100, various changes may be made to FIG. 11. For example, while shown as a series of steps, various steps in FIG. 11 could overlap, occur in parallel, occur in a different order, occur any number of times, be omitted, or replaced by other steps.

In some embodiments, when receiving a frame with preliminary FCS present, the NAV setting behavior of the receiver may depend on one or more of:
Whether the PPDU containing the frame is classified as an intra-BSS PPDU, inter-BSS PPDU or unclear.
Whether the receiver performs CRC check both the preliminary FCS field and the FCS field of the frame.
Whether the CRC check on the preliminary FCS field, if performed, passes or fails.
Whether the CRC check on the FCS field, if performed, passes or fails.
The received signal strength of the PPDU.

In some embodiments, if the CRC check on the FCS field is performed but not on preliminary FCS field, then the receiver behavior may be similar to the existing wireless network behavior. The appropriate NAV (basic or intra-BSS) may be updated based on the Duration field of the MAC frame if the CRC check passes.

In some embodiments, the NAV value to use may also depend on one or more of:
the duration of the PPDU containing the frame. This can be obtained, for example, from the L-SIG field of the header,
the location of the Preliminary FCS field within the PPDU. This may, for example, be indicated using a dedicated Preliminary FCS location indication field or may be inferred by the receiver based on observed location of the field,
the time when the NAV update operation is performed within the received frame.

In some embodiments, the NAV update may be performed at the time of the successful CRC check of the preliminary FCS field. In some embodiments, the NAV update may be performed at another time within the frame after the CRC check, such as the expected time of the end of the PPDU containing the MAC frame with the preliminary FCS field, or upon triggering of some primitive (e.g., the PHY-RXEND. indication). For example, after a successful CRC check on the preliminary FCS field:
If the NAV duration is set by the receiver at the time of successful CRC check, then the updated NAV may be set to: Duration field of MAC header of the frame containing the preliminary FCS+Remaining duration of PPDU after finishing the CRC check on preliminary FCS.
If the NAV duration is set by the receiver at the expected end time of the PPDU (as indicated in the L-SIG field), then the updated NAV may be set to the Duration field of the MAC header of the frame containing the preliminary FCS.
If the NAV duration is set by the receiver at an instant of the received PPDU that is after a time t from the start of the PPDU, then the updated NAV may be set to: Duration field of the MAC header+PPDU duration−t.

In some embodiments, if the CRC check on the preliminary FCS is performed but a CRC check is not performed on the FCS field, the appropriate NAV (basic or intra-BSS) may be updated based on the Duration field of the MAC frame if the CRC check passes. In some embodiments, if the CRC check passes and the frame is determined to be an intra-BSS PPDU, then the intra-BSS may be updated based on the Duration field of the MAC frame if the CRC check passes. In some embodiments, if the CRC check passes but the frame is determined to be from another BSS or cannot be classified as intra-BSS or inter-BSS, then the NAV may not be updated based on the passing of the CRC check value. If the CRC check fails, then the NAV may not be updated based on the frame.

In some embodiments, if the CRC check on both the preliminary FCS and the FCS field are performed, then the receiver behavior may be determined by the result of the CRC check of the FCS field, independent of the result of the CRC check on the preliminary FCS field. This may be similar to the existing wireless network behavior.

In some embodiments, if the CRC check on both the preliminary FCS and the FCS field are performed, the receiver may set the NAV based on the Duration field of the received MAC frame, if the preliminary FCS CRC check passes, independent of the result of the CRC check on the FCS field.

In some embodiments, if the CRC check on both the preliminary FCS and the FCS field are performed, the NAV may be updated for a receive frame if both the CRC checks on preliminary FCS and the FCS field pass.

In some embodiments, if the CRC check on both the preliminary FCS and the FCS field are performed, the NAV may be updated for a receive frame if either of the CRC checks on the preliminary FCS or the FCS field pass.

In some embodiments, if the CRC check on both the preliminary FCS and the FCS field are performed, if the CRC check on both the preliminary FCS and the FCS field fails, the NAV may not be updated based on the received frame.

In some embodiments, if the CRC check on both the preliminary FCS and the FCS field are performed, if the CRC check on either the preliminary FCS or the FCS field fails, the NAV may not be updated based on the received frame.

In some embodiments, if the CRC check on both the preliminary FCS and the FCS field are performed, if the CRC check on the preliminary FCS passes, and if the PPDU containing the frame is determined to be an intra-BSS PPDU, then the NAV may be updated based on the passing of this CRC check. If the PPDU containing the frame is determined to be an inter-BSS PPDU or cannot be determined to be intra or inter-BSS, then additionally the CRC check of the FCS field may be needed to pass to update the NAV based on the frame duration.

In some embodiments, if the CRC check on both the preliminary FCS and the FCS field are performed, if the preliminary FCS CRC check fails, then independent of the result of the CRC check of the FCS field, the receiver may behave as if the CRC check on the FCS field has failed, and may not update its NAV duration.

In some embodiments, if the receiver is an intended recipient of the frame, and it is expected that there may be information present for the receiver in the frame after the preliminary FCS field, then the receiver may not update the NAV duration based on the successful CRC check of the preliminary FCS field value. In this case, the NAV setting may be determined based on the CRC check of the FCS field.

In some embodiments, if the receiver is an intended recipient of the frame, and it is not expected that there will be any information present for the receiver in the frame after the preliminary FCS field, then the receiver may update the NAV duration based on the successful CRC check on the preliminary FCS field value. This may be applicable, for example, to the STAs that are expected to use the preliminary FCS field to early terminate the reception of the frame (e.g., NPCA STAs, DSO STAs, DPS STAs etc.).

In the above embodiments, some of the existing rules on setting the NAV, related to classification of the PPDU as intra-BSS or inter-BSS, the received signal power being above some thresholds, e.g., −82 dBm may still apply.

In some embodiments, if a received frame has a preliminary FCS field present, the criteria for whether the receiver needs to perform CRC check on both the preliminary FCS and the FCS field can be determined based on one or more of:
Whether the receiver has indicated that it will perform CRC check on preliminary FCS
Whether the frame is addressed to the receiver, as determined from the MAC header
The result of the CRC check on the preliminary FCS
Whether the PPDU containing the frame is an intra-BSS PPDU or an inter-BSS PPDU or cannot be distinguished as either intra-BSS or inter-BSS.
The received signal strength of the PPDU.
Whether the receiver has enabled any power saving mechanism such as intra-PPDU power save.

In some embodiments, a STA beyond a certain Wi-Fi generation (e.g., a UHR STA) that receives a trigger frame containing a preliminary FCS field and that is not expected to receive the fields of the trigger frame present after the preliminary FCS field may treat the frame reception as successful and may attempt to update NAV, if the CRC check on the preliminary FCS field passes, independent of the result of the CRC check performed on the FCS field. In some embodiment, the preliminary FCS field may be same as the intermediate FCS field. In some embodiments, if a UHR STA receives a trigger frame that is an initial Control frame that contains an intermediate FCS and the STA is not expected to receive the fields of the trigger frame present after the intermediate FCS, then the STA may treat the frame reception as successful, if the CRC check on the intermediate FCS is performed, it passes, and the STA also performs a CRC check on the FCS field.

In some embodiments, a STA beyond a certain Wi-Fi generation (e.g., a UHR STA) that receives a trigger frame containing a preliminary FCS field and that is expected to receive the fields of the trigger frame present after the preliminary FCS field may not treat the frame reception as successful/unsuccessful and may not attempt to update a NAV, based on the CRC check on the intermediate FCS. In this case, the STA may continue reception of the frame and perform a CRC check on the FCS field. In some examples, the preliminary FCS field may be the same as the intermediate FCS field.

In some embodiments, a STA beyond a certain Wi-Fi generation (e.g., a UHR STA) that terminates reception of a trigger frame after the reception of a preliminary FCS field or equivalently doesn't perform the CRC check on the FCS field, may treat the frame reception as successful and may attempt to update the NAV, if the CRC check on the preliminary FCS field passes. In some embodiments, this attempt to treat the frame reception as being successful and update the NAV can be mandatory. In some embodiments, the preliminary FCS field may be the same as the intermediate FCS field. In embodiments such as these, if a UHR STA receives a trigger frame that is an initial control frame that contains an intermediate FCS and the STA is not expected to receive the fields of the trigger frame present after the intermediate FCS, then the STA may treat the frame reception as successful if the CRC check on the intermediate FCS field is performed, the CRC check passes, and the STA does not perform a CRC check on the FCS field. In some embodiments, this treatment of frame reception as successful may be mandatory.

In some embodiments, to update the NAV based on the passing of the CRC check on the preliminary FCS field of a trigger frame, a STA may follow existing wireless network procedures in the setting and resetting of NAVs, where the NAV update can be, either:
performed at the expected end time of the PPDU containing the trigger frame, where the expected end time is determined from the L-SIG field, or
performed at the time of the CRC check, but the update is performed such that the resulting behavior of the update is equivalent to having performed the NAV update at the expected end time of the PPDU containing the trigger frame. In other words, the NAV value at the expected end time of the PPDU remains the same in both cases.
   In some embodiments, the preliminary FCS field may be same as the intermediate FCS field.

In some embodiments, a STA beyond a certain Wi-Fi generation (e.g., a UHR STA) that terminates reception of a trigger frame after the reception of a preliminary FCS field may not initiate channel contention until the expected end time of the PPDU containing the trigger frame if the CRC check on the intermediate FCS field fails. In some embodiments, this behavior for deferred channel contention may be mandatory. In some embodiments, the preliminary FCS field may be the same as the intermediate FCS field.

In some embodiments, a STA beyond a certain Wi-Fi generation (e.g., a UHR STA) that receives a trigger frame containing a preliminary FCS field may treat the frame reception as unsuccessful if the CRC check on the intermediate FCS field fails. In some embodiments, this behavior for treating the frame reception as unsuccessful may be mandatory. In some embodiments, the preliminary FCS field may be same as the intermediate FCS field.

Consider a BSS where an AP has enabled NPCA operation and the AP has one or more associated non-AP STAs that have enabled NPCA operation. In some embodiments, predefined specifications for a wireless network may not allow triggering of NPCA operation based on early termination of reception of a frame from another BSS based on the correctness check of the preliminary FCS present in the frame. In embodiments such as these, the NPCA switch may be performed after the end of the trigger frame after performing the FCS check on the FCS field of the frame, if other necessary conditions are satisfied. In some embodiments, the NPCA AP may indicate whether the NPCA switch may be initiated based on preliminary FCS or based on the FCS check, when the preliminary FCS is present in a trigger frame.

In some embodiments, when receiving a frame containing a preliminary FCS, an NPCA-supporting STA of a BSS may determine if the frame is eligible for NPCA switch based on one or more of:
Determination that the PPDU containing the frame is from another BSS,
Information contained within the received PPDU.
The time of reception of the preliminary FCS and the result of the preliminary FCS check.
The time of the end of the PPDU and the result of the FCS check.
Rules for performing switch to NPCA channel based on the preliminary FCS check, as indicated by predefined specifications for the wireless network or by the AP when enabling NPCA.

The time of checking the eligibility of the frame for NPCA switch may be one or more of:
A fixed duration after the PHY header of the received frame.
A fixed duration after the reception of the preliminary FCS field of the frame.
A fixed duration after the reception of the FCS field of the frame.
A fixed duration after the end of the PPDU containing the frame.
   The time of checking for the eligibility may be determined by a set of rules indicated in predefined specifications for the wireless network and/or indicated by the AP for the BSS.

In some embodiments, when receiving a frame containing a preliminary FCS and if necessary conditions for NPCA switch are satisfied, the start time for the switch to the NPCA channel can be one of:
A fixed duration after the PHY header of the received frame.
A fixed duration after the reception of the preliminary FCS field of the frame.
A fixed duration after the reception of the FCS field of the frame.
A fixed duration after the end of the PPDU containing the frame.

An NPCA-supporting STA of a BSS may determine the applicable start time for switch to an NPCA backup primary channel based on one or more of:
Determination that the PPDU containing the frame is from another BSS,
Information contained within the received PPDU.
The time of reception of the preliminary FCS and the result of the preliminary FCS check.
The time of the end of the PPDU and the result of the FCS check.
Rules for performing switch to NPCA channel based on the preliminary FCS check, as indicated by predefined specifications for a wireless network or by the AP when enabling NPCA.
The time of checking for the NPCA switch eligibility by the STA.

In some embodiments, a STA may determine the sufficiency conditions for NPCA switch based on the preliminary FCS check, but the switch to the NPCA primary channel may be performed after the end of PPDU containing the frame. In some embodiments, a STA may determine the sufficiency conditions for the NPCA switch based on the preliminary FCS check, and if the necessary conditions are met, the switch may be performed after the reception of the preliminary FCS field. In some embodiments, the AP when enabling NPCA operation may indicate whether the NPCA switch may be initiated based on preliminary FCS or based on the FCS check, when the preliminary FCS is present in a trigger frame. The AP may use the former option, for example, if all associated NPCA STAs support performing a preliminary FCS check. If the AP indicates that the NPCA switch can be performed based on the FCS check, then the STAs and the AP may trigger the switch to the NPCA channel within a fixed delay of receiving the preliminary FCS field from a frame that is eligible for NPCA switch.

In some embodiments, the AP may determine the start time for transmission to a non-AP STA on the NPCA primary channel based on one or more of:
The time of reception of the preliminary FCS in a frame.
The NPCA Padding delay or switching delay indicated by the non-AP STA.
The NPCA Padding delay or switching delay indicated by the AP.
The time of the end of the PPDU containing the frame.
The indication by the non-AP STA of whether it will perform switch to NPCA channel based on the preliminary FCS check.
The expected time of initiating switch to the NPCA backup primary channel by the non-AP STA.
   For example, if the non-AP STA indicates that it will perform NPCA switch after the preliminary FCS, the NPCA Padding delay of the non-AP STA may be counted from the time of reception of the preliminary FCS field.

In some embodiments, an NPCA supporting STA may determine the start time for channel contention on the NPCA primary channel based on one or more of:
The time of reception of the preliminary FCS in a frame.
The NPCA Padding delay or switching delay indicated by the STA.
The NPCA Padding delay or switching delay indicated by the associated AP, if applicable.
The time of the end of the PPDU containing the frame.
The time of initiating switch to the NPCA backup primary channel by the STA.
The expected time of initiating switch to the NPCA backup primary channel by the associated AP, if applicable.
   In some embodiments, a non-AP STA may determine the sufficiency conditions for NPCA switch based on the preliminary FCS check and initiate the switch after the preliminary FCS check, but the channel contention may be initiated only after the NPCA trigger time, which is determined based on the end of the frame that caused the NPCA switch. In some embodiments, the non-AP STA may indicate to the AP that the non-AP STA may perform the NPCA channel switch based on the preliminary FCS, if present within the observed frame.

Consider a BSS where an AP has enabled spatial reuse operation and the AP has one or more associated non-AP UHR STAs that support spatial reuse operation. In some embodiments, all or some of the behavior described above regarding NPCA may also be applied for spatial reuse operation within the BSS.

In some embodiments, predefined specifications for the wireless network may not allow triggering of spatial reuse operation based on early termination of reception of a pre-HE frame from another BSS based on the correctness check of the preliminary FCS present in the frame. In some embodiments, the AP may indicate whether the spatial reuse operation may be initiated based on preliminary FCS or based on the FCS check, when the preliminary FCS is present in a trigger frame. In the former case, if the FCS check passes on the preliminary FCS, then the BSS Color information and NAV information obtained from the frame can be used performing the spatial reuse operation. In other words, if the BSS color indicates that the frame is from another BSS, then the receiving STA may contend for channel access, and transmit a frame in parallel. In some embodiments the transmission time is not bounded. In some embodiments, the transmit time may be limited to the NAV time indicated in the received frame. Additional bevahior on the transmit power to be used by the STA may still be applicable, as specified in predefined specifications for the wireless network regarding spatial reuse. The NAV time from the observed transmission, when preliminary FCS is present, may be computed as described above in this disclosure.

Although the embodiments above may be described with respect to a preliminary FCS, the same behaviors may also be applicable when an intermediate FCS is present in the frame.

In some embodiments, during multi-AP coordination, within the coordination process, a frame exchange may be defined for an AP to request a neighboring AP to include preliminary FCS within MAC frames transmitted within the neighboring AP's BSS.

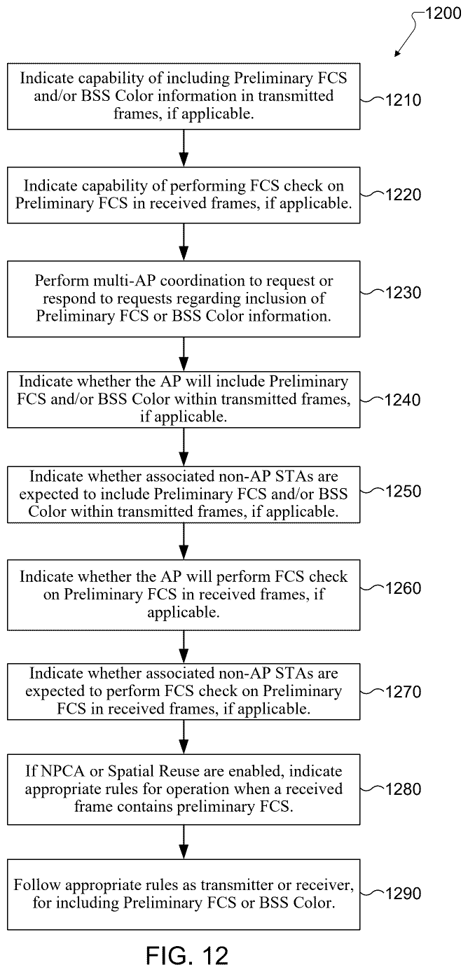

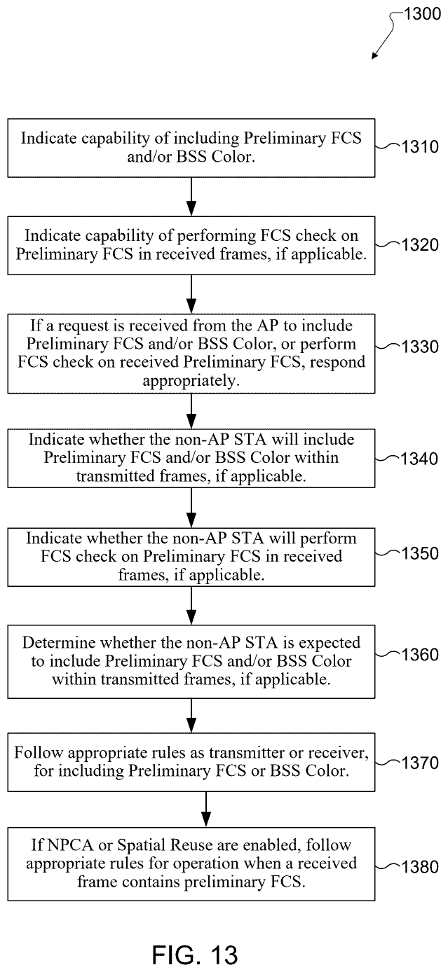

A flow diagram illustrating an example sequence of steps performed by an AP for enabling indication of BSS Color and/or Preliminary FCS is provided in FIG. 12. Example operations performed by a non-AP STA for supporting indication of BSS Color and/or Preliminary FCS are provided in FIG. 13.

FIG. 12 illustrates an example method performed by an AP for enabling indication of BSS Color and/or Preliminary FCS and performing an FCS check on a received preliminary FCS 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method performed by an AP for enabling indication of BSS Color and/or Preliminary FCS and performing an FCS check on a received preliminary FCS could be used without departing from the scope of this disclosure.

In the example of FIG. 12, method 1200 begins at step 1210. At step 1210, an AP indicates capability of including Preliminary FCS and/or BSS Color information in transmitted frames, if applicable. At step 1220, the AP indicates capability of performing FCS check on Preliminary FCS in received frames, if applicable.

At step 1230, the AP performs multi-AP coordination to request or respond to requests regarding inclusion of Preliminary FCS or BSS Color information.

At step 1240, the AP indicates whether the AP will include Preliminary FCS and/or BSS Color within transmitted frames, if applicable. At step 1250, The AP indicates whether associated non-AP STAs are expected to include Preliminary FCS and/or BSS Color within transmitted frames, if applicable.

At step 1260, the AP indicates whether the AP will perform FCS check on Preliminary FCS in received frames, if applicable. At step 1270, the AP indicates whether associated non-AP STAs are expected to perform FCS check on Preliminary FCS in received frames, if applicable.

At step 1280, If NPCA or Spatial Reuse are enabled, the AP indicates appropriate rules for operation when a received frame contains preliminary FCS.

At step 1290, the AP follows appropriate rules, as transmitter or receiver, for including Preliminary FCS or BSS Color.

Although FIG. 12 illustrates one example method performed by an AP for enabling indication of BSS Color and/or Preliminary FCS and performing an FCS check on a received preliminary FCS 1200, various changes may be made to FIG. 12. For example, while shown as a series of steps, various steps in FIG. 12 could overlap, occur in parallel, occur in a different order, occur any number of times, be omitted, or replaced by other steps.

FIG. 13 illustrates an example method performed by a non-AP STA for supporting indication of BSS Color and/or Preliminary FCS and performing an FCS check on a received preliminary FCS 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method performed by a non-AP STA for supporting indication of BSS Color and/or Preliminary FCS and performing an FCS check could be used without departing from the scope of this disclosure.

In the example of FIG. 13, method 1300 begins at step 1310. At step 1310, a non-AP STA indicates capability of including Preliminary FCS and/or BSS Color. At step 1320, the non-AP STA indicates capability of performing FCS check on Preliminary FCS in received frames, if applicable.

At step 1330, if a request is received from an AP to include Preliminary FCS and/or BSS Color, or perform FCS check on received Preliminary FCS, the non-AP STA responds appropriately.

At step 1340, the non-AP STA indicates whether the non-AP STA will include Preliminary FCS and/or BSS Color within transmitted frames, if applicable. At step 1350, the non-AP STA indicates whether the non-AP STA will perform an FCS check on a Preliminary FCS in received frames, if applicable. At step 1360, the non-AP STA determines whether the non-AP STA is expected to include Preliminary FCS and/or BSS Color within transmitted frames, if applicable.

At step 1370, the non-AP STA follows appropriate rules as transmitter or receiver, for including Preliminary FCS or BSS Color.

At step 1380, If NPCA or Spatial Reuse are enabled, the non-AP STA follows appropriate rules for operation when a received frame contains a preliminary FCS.

Although FIG. 13 illustrates one example method by a non-AP STA for supporting indication of BSS Color and/or Preliminary FCS and performing an FCS check 1300, various changes may be made to FIG. 13. For example, while shown as a series of steps, various steps in FIG. 13 could overlap, occur in parallel, occur in a different order, occur any number of times, be omitted, or replaced by other steps.

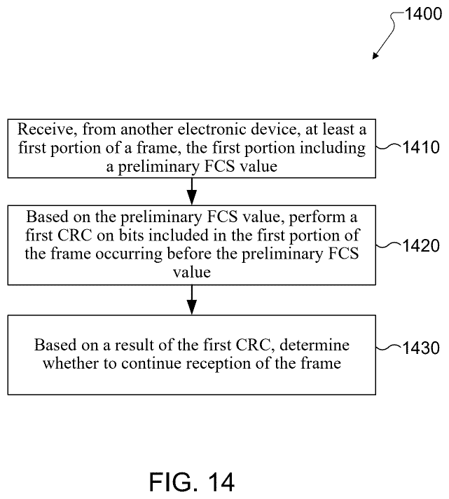

FIG. 14 illustrates an example method for carrying additional FCS and BSS color information in UHR frames 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for a method for carrying additional FCS and BSS color information in UHR frames could be used without departing from the scope of this disclosure.

In the example of FIG. 14, method 1400 begins at step 1410. At step 1410, an electronic device (such as a non-AP STA) receives, from another electronic device (such as an AP), at least a first portion of a frame, the first portion including a preliminary FCS value.

In some embodiments, the frame may be a trigger frame that is an ICF, and the electronic device may consider reception of the frame as successful if the first CRC passes.

In some embodiments, the frame may be a trigger frame that is an ICF, and the electronic device may consider reception of the frame as unsuccessful if the first CRC fails.

In some embodiments, the first portion of the frame may include at least one of (i) an indication that the frame includes the preliminary FCS value and, and (ii) an indication of a location of the preliminary FCS within the frame.

In some embodiments, the first portion of the frame includes a BSS color value preceding the preliminary FCS value.

At step 1420, based on the preliminary FCS value, the electronic device performs a first CRC on bits included in the first portion of the frame occurring before the preliminary FCS value.

At step 1430, based on a result of the first CRC, the electronic device determines whether to continue reception of the frame.

In some embodiments, the electronic device may early terminate reception of the frame upon satisfaction of one or more of the following conditions:
information in the frame or a PPDU containing the frame suggests that the electronic devices is not an intended recipient of the frame;
the first CRC fails;
the electronic device has indicated to the other electronic device that the electronic device will perform a CRC if a preliminary FCS is present in a received frame; and
the first CRC passes, and the electronic device is not expected to receive any fields of the frame present after a field including the preliminary FCS value.

In some embodiments, the early termination of receipt of the frame may include on or more of:
sending a primitive from a MAC layer to a PHY layer;
refraining from receiving at least part of the frame;
refraining from performing a second CRC on an FCS field present in the frame; and
refraining from setting a NAV value for the frame.

In some embodiments, the electronic devices may determine whether to set an NAV for the frame based on one or more of the following:
a classification status of the frame as an intra-BSS or inter-BSS frame;
whether the electronic device performs a CRC on both the preliminary FCS value and an FCS value;
the result of the first CRC;
the result of a second CRC performed on bits included in the frame occurring before the FCS value; and
a result of a determination whether reception of the frame is successful.

In some embodiments, prior to reception of the first portion of the frame, the electronic device may transmit, to the other electronic device, a message including an indication that the electronic device will perform CRC on any frames that include preliminary FCS values.

In some embodiments, (i) the electronic device is associated with a first BSS, (ii) the other electronic device is associated with a second BSS, and (iii) the electronic is configured to refrain from triggering NPCA operation based on a decision to early terminate the frame based on the result of the CRC.

In some embodiments, (i) the electronic device is associated with a first BSS, (ii) the other electronic device is associated with a second BSS, (iii) the frame is a pre-HE frame; and(iv) the electronic is configured to refrain from triggering spatial reuse operation based on a decision to early terminate the frame based on the result of the CRC.

Although FIG. 14 illustrates one example method for carrying additional FCS and BSS color information in UHR frames 1400, various changes may be made to FIG. 14. For example, while shown as a series of steps, various steps in FIG. 14 could overlap, occur in parallel, occur in a different order, occur any number of times, be omitted, or replaced by other steps.

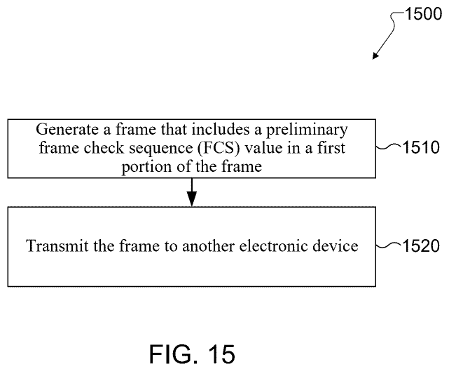

FIG. 15 illustrates another example method for carrying additional FCS and BSS color information in UHR frames 1500 according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for carrying additional FCS and BSS color information in UHR frames could be used without departing from the scope of this disclosure.

In the example of FIG. 15, method 1500 begins at step 1510. At step 1510, an electronic device (such as an AP) generates a frame that includes a preliminary FCS value in a first portion of the frame.

In some embodiments, the frame is a trigger frame that is an ICF.

In some embodiments, the electronic device includes the preliminary FCS value in the first portion of the frame based on at least one of following:
a capability of the electronic device to include the preliminary FCS value in the first portion of the frame;
a physical layer protocol data unit (PPDU) format of the frame;
   a type of the frame;
whether the frame is individually addressed or a broadcast frame;
   a duration of the frame;
whether the frame updates a previously set network allocation vector (NAV)
whether an intermediate FCS value is in the frame; and
an indication from another electronic device to include the preliminary FCS value.

In some embodiments, the first portion of the frame may include at least one of (i) an indication that the frame includes the preliminary FCS value, and (ii) an indication of a location of the preliminary FCS within the frame.

In some embodiments, the first portion of the frame may include a BSS color value preceding the preliminary FCS value.

At step 1520, the electronic device transmits the frame to another electronic device (such as a non-AP STA).

In some embodiments, prior to transmission of the frame, the electronic device may transmit, to the other electronic device, a message including an indication that the frame will include the preliminary FCS value.

In some embodiments, prior to transmission of the frame, the electronic devices may receive, from the other electronic device, a message including an indication that the other electronic device is capable of performing CRCs based on preliminary FCS values.

In some embodiments, prior to transmission of the frame, the electronic device may receive, from the other electronic device, a message including an indication that the other electronic device will perform CRC on any frame that include preliminary FCS values.

In some embodiments, (i) the electronic device may be associated with a BSS; (ii), the other device may be associated with a second BSS, and (iii) the frame may be a pre-HE-frame.

Although FIG. 15 illustrates one example method for carrying additional FCS and BSS color information in UHR frames 1500, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed IS:

1. An electronic device comprising:
a transceiver configured to receive, from another electronic device, at least a first portion of a frame, the first portion including a preliminary frame check sequence (FCS) value; and
a processor operably coupled to the transceiver, the processor configured to:
based on the preliminary FCS value, perform a first cyclic redundancy check (CRC) on bits included in the first portion of the frame occurring before the preliminary FCS value; and
based on a result of the first CRC, determine whether to continue reception of the frame.

2. The electronic device of claim 1, wherein:
the frame is a trigger frame that is an initial control frame (ICF); and
the processor is further configured to consider reception of the frame as successful if the first CRC passes.

3. The electronic device of claim 1, wherein:
the frame is a trigger frame that is an initial control frame (ICF); and
the processor is further configured to consider reception of the frame as unsuccessful if the first CRC fails.

4. The electronic device of claim 1, wherein the processor is further configured to early terminate reception of the frame upon satisfaction of one or more of the following conditions:
information in the frame or a physical layer protocol data unit (PPDU) containing the frame suggests that the electronic device is not an intended recipient of the frame;
the first CRC fails;
the electronic device has indicated to the other electronic device that the electronic device will perform a CRC if a preliminary FCS is present in a received frame; and
the first CRC passes and the electronic device is not expected to receive any fields of the frame present after a field including the preliminary FCS value.

5. The electronic device of claim 4, where the early termination of reception of the frame includes at least one of:
sending a primitive from a media access control (MAC) layer to a physical (PHY) layer;
refraining from receiving at least a part of the frame;
refraining from performing a second CRC on an FCS field present in the frame; and
refraining from setting a network allocation vector (NAV) value for the frame.

6. The electronic device of claim 1, wherein the first portion of the frame includes at least one of (i) indication that the frame includes the preliminary FCS value, and (ii) an indication of a location of the preliminary FCS within the frame.

7. The electronic device of claim 1, wherein the first portion of the frame includes a basic service set (BSS) color value preceding the preliminary FCS value.

8. The electronic device of claim 1, wherein the transceiver is further configured to determine whether to set a network allocation vector (NAV) for the frame based on at least one of:
a classification status of the frame as an intra-basic service set (BSS) or inter-BSS frame;
whether the electronic device performs a CRC on both the preliminary FCS value and an FCS value;
the result of the first CRC;
a result of a second CRC performed on bits included in the frame occurring before the FCS value; and
a result of a determination whether reception of the frame is successful.

9. The electronic device of claim 1, wherein the transceiver is further configured to, prior to reception of the first portion of the frame, transmit, to the other electronic device, a message including an indication that the electronic device will perform CRC on any frames that include preliminary FCS values.

10. The electronic device of claim 1, wherein:
the electronic device is associated with a first basic service set (BSS);
the other electronic device is associated with a second BSS; and
the processor is further configured to refrain from triggering non-primary channel access (NPCA) operation based on a decision to early terminate the frame based on the result of the CRC.

11. The electronic device of claim 1, wherein:
the electronic device is associated with a first basic service set (BSS);
the other electronic device is associated with a second BSS;
the frame is a pre-high efficiency (HE) frame; and
the processor is further configured to refrain from triggering spatial reuse operation based on a decision to early terminate the frame based on the result of the CRC.

12. An electronic device comprising:
a processor configured to generate a frame that includes a preliminary frame check sequence (FCS) value in a first portion of the frame; and
a transceiver operably coupled to the processor, the transceiver configured to transmit the frame to another electronic device.

13. The electronic device of claim 12, wherein the frame is a trigger frame that is an initial control frame (ICF).

14. The electronic device of claim 12, wherein the processor is further configured to include the preliminary FCS value in the first portion of the frame based on at least one of:
a capability of the electronic device to include the preliminary FCS value in the first portion of the frame;
a physical layer protocol data unit (PPDU) format of the frame;
a type of the frame;
whether the frame is individually addressed or a broadcast frame;
a duration of the frame;
whether the frame updates a previously set network allocation vector (NAV)
whether an intermediate FCS value is in the frame; and
an indication from another electronic device to include the preliminary FCS value.

15. The electronic device of claim 12, wherein the first portion of the frame includes at least one of (i) an indication that the frame includes the preliminary FCS value, and (ii) an indication of a location of the preliminary FCS within the frame.

16. The electronic device of claim 12, wherein the first portion of the frame includes a basic service set (BSS) color value preceding the preliminary FCS value.

17. The electronic device of claim 12, wherein the transceiver is further configured to, prior to transmission of the frame, transmit, to the other electronic device, a message including an indication that the frame will include the preliminary FCS value.

18. The electronic device of claim 12, wherein the transceiver is further configured to, prior to transmission of the frame, receive, from the other electronic device, a message including an indication that the other electronic device is capable of performing CRCs based on preliminary FCS values.

19. The electronic device of claim 12, wherein the transceiver is further configured to, prior to transmission of frame, receive, from the other electronic device, a message including an indication that the other electronic device will perform CRC on any frames that include preliminary FCS values.

20. The electronic device of claim 12, wherein:
the electronic device is associated with a first basic service set (BSS);
the other electronic device is associated with a second BSS; and
the frame is a pre-high efficiency (HE) frame.
